(19) United States
(12) Patent Application Publication
(10) Pub. No.: US 2018/0119245 A1
(43) Pub. Date: May 3, 2018

(54) HIGH ELONGATION PRESS HARDENED STEEL AND MANUFACTURE OF THE SAME

(71) Applicant: AK Steel Properties, Inc., West Chester, OH (US)

(72) Inventors: John Andrew Roubidoux, Cody, WY (US); Erik James Pavlina, Lebanon, OH (US)

(21) Appl. No.: 15/723,812

(22) Filed: Oct. 3, 2017

Related U.S. Application Data
(60) Provisional application No. 62/403,354, filed on Oct. 3, 2016.
(60) Provisional application No. 62/406,715, filed on Oct. 11, 2016.
(60) Provisional application No. 62/457,575, filed on Feb. 10, 2017.

(51) Int. Cl. C21D 9/46; B32B 15/01; C22C 38/38; C22C 38/32; C22C 38/28; C22C 38/26; C22C 38/02; C22C 38/00; C21D 1/26; C21D 8/02; C21D 6/00

(52) U.S. Cl. CPC C21D 9/46; C21D 2211/001; B32B 15/013; C22C 38/38; C22C 38/32; C22C 38/28; C22C 38/26; C22C 38/02; C22C 38/008; C22C 38/001; C21D 1/26; C21D 8/0205; C21D 6/008; C21D 6/005; C21D 6/002; B32B 15/012

(57) ABSTRACT

The residual ductility of currently available press hardened steel is approximately six percent. This characteristic of the material is primarily due to the fully martensitic microstructure in the hot stamped condition. The present alloys and processing improve the residual ductility of steels for use in press hardening applications. A series of specialized heat treatments were applied to a variety of new alloys to obtain higher residual ductility and a significant volume fraction of retained austenite in the as-hot stamped microstructure.

### PRIORITY

This application claims priority to U.S. Provisional Application Serial Nos. 62/403,354 filed Oct. 3, 2016, entitled “High Elongation Press Hardened Steel and Manufacture of the Same;” 62/406,715 filed Oct. 11, 2016, entitled “Zinc Coated Press Hardened Steel and Manufacture of the Same;” and 62/457,575 filed Feb. 10, 2017, entitled “Uncoated Press Hardened Steel Alloys with Improved Residual Ductility;” the disclosures of each of which are incorporated by reference herein.

### BACKGROUND

The present application relates to an improvement in press hardened steels, hot press forming steels, hot stamping steels, or any other steel that is heated to an austenitization temperature and formed and quenched in a stamping die to achieve desired mechanical properties in the final part. These types of steels are also sometimes referred to as “22MnB5” or “heat treatable boron-containing steels.” In this application, they will all be referred to as “press hardened steels.”

Press hardened steels are primarily used as structural members in automobiles where high strength, low weight, and improved intrusion resistance is desired by automobile manufacturers. A common structural member where press hardened steels are employed in the automobile structure is the B-pillar.

Current industrial processing of prior art press hardened steel involves heating a blank (piece of steel sheet) to a temperature greater than the A₃ temperature (the austenitization temperature), typically in the range 900-950° C., holding the material at that temperature for a certain duration, placing the austenitized blank into a hot stamping die, forming the blank to the desired shape, and quenching the material in the die to a low temperature such that martensite is formed. The end result is a material with a high ultimate tensile strength and a fully martensitic microstructure.

The as-quenched microstructure of prior art press hardened steel is fully martensitic. Conventional press hardened steels have ultimate tensile strengths of approximately 1500 MPa and total elongations on the order of 6%.

### SUMMARY

The steels of the present application improve upon currently available press hardened steel alloys by using chemistry and processing to achieve higher elongation or residual ductility in the press hardened condition. Residual ductility refers to the ductility the material has in the press hardened condition.

The strength-ductility property of embodiments of the present steel alloys include ultimate tensile strengths greater than or equal to 1100 MPa and elongations greater than or equal to 8%. Certain embodiments of the present steel alloys can be subjected to short intercritical annealing times and a relatively low intercritical annealing temperature.

### DESCRIPTION OF DRAWINGS

FIG. 1 is a thermal profile and processing schematic for embodiments of the present alloys.

FIG. 2 is a plot of temperature as a function of Mn content showing the effect of Mn on the A₁ and A₃ temperatures of embodiments of the steel alloys.

FIG. 3 is a plot of retained austenite as a function of intercritical annealing time determined by electron backscatter diffraction (EBSD) measurements for certain embodiments of the present alloys.

FIG. 4 is a plot of engineering stress as a function of engineering strain for embodiments of the present alloys and certain prior art press hardened steel alloys.

FIG. 5 is a plot of total elongation as a function of tensile strength for embodiments of the present alloys.

FIG. 6 shows the results of EBSD analysis for an embodiment of the present alloys.

FIG. 7 shows the results of EBSD analysis for an embodiment of the present alloys.

FIG. 8 shows the results of EBSD analysis for an embodiment of the present alloys.

FIG. 9 shows the results of EBSD analysis for an embodiment of the present alloys.

FIG. 10A is a plot of engineering stress-strain curves for embodiments of the present alloys intercritically annealed at 710° C. for times ranging from 3-20 minutes. FIG. 10B is a plot of engineering stress-strain curves for the embodiments austenitized at 745° C. for times ranging from 3-20 minutes.

FIG. 11A is a plot of total elongation as a function of tensile strength for embodiments of the present alloys. FIG. 11B is a plot summarizing yield strength, ultimate tensile strength, and total elongation as a function of annealing time for the embodiments.

FIG. 12A shows microstructure of an embodiment of the present alloys intercritically annealed for 4 minutes at 710° C. FIG. 12B shows microstructure of the embodiment austenitized for 4 minutes at 745° C. and hot stamped to achieve the final fully martensitic microstructure.

### DETAILED DESCRIPTION

For Fe—C—Mn alloys such as press hardened steels, increasing the manganese content lowers the A₁ and A₃ temperatures. The A₁ temperature is the temperature at which austenite begins to form, that is, it is the temperature above which the steel is in a phase field comprising austenite and ferrite, and the A₃ temperature is the boundary between the austenite+ferrite and austenite phase fields. The benefits of lower A₁ and A₃ temperatures for steel alloys of the present application to be used in a press hardening process include the following:
Lowers the temperature to achieve full austenization. Full austenization can be achieved at temperatures as low as 600° C. for higher manganese concentrations.
Allows for the possibility of intercritically annealing the material.
Permits tailoring the microstructure to achieve desired mechanical properties in the final hot stamped part; that is, retained austenite in the as-die quenched microstructure.

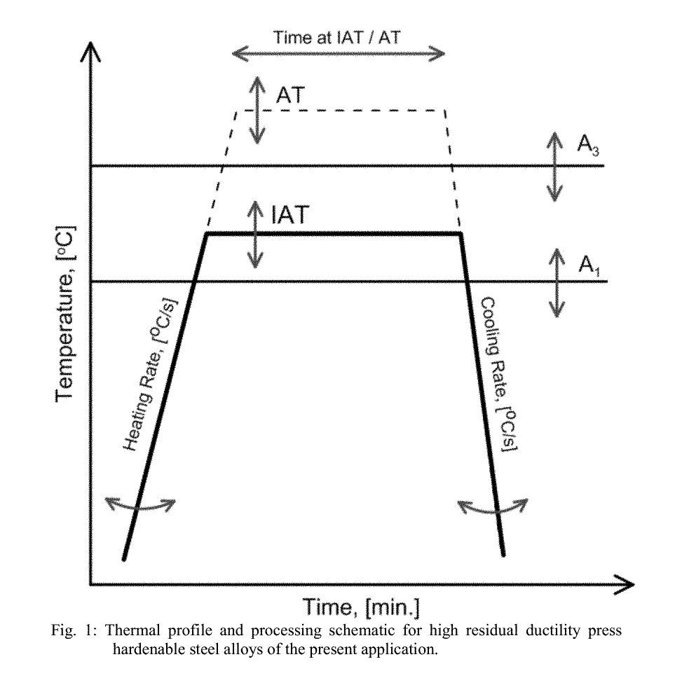

FIG. 1 depicts a schematic of the thermal profile during hot stamping for the embodiments of the present alloys. IAT represents the intercritical annealing temperature (that is, temperatures between the A₁ and A₃ temperatures) and AT represents the austenitization temperature (that is, above the A₃ temperature). The arrows indicate the flexibility in the processing of the alloys to achieve desired properties.

In embodiments of the present alloys, manganese is the primary alloying addition used to tailor the processing temperatures of the alloys. Aluminum, silicon, chromium, molybdenum, and carbon can also be similarly used to tailor processing temperatures. From FIG. 1, it can be seen that manganese concentration affords increased processing flexibility for the manufacture of the present alloys. For example, increasing manganese decreases the A₁ and A₃ temperatures in addition to reducing the critical cooling rate (that is, the cooling rate required to form martensite) for the alloy. This flexibility is particularly true when compared to the processing of currently available press hardened steels. The double-ended arrows indicate that varying levels of manganese provide the flexibility to vary these parameters to design the desired final microstructure and mechanical properties in the as-die quenched part.

In addition to iron and other impurities incidental to steelmaking, the embodiments of the present alloys include manganese, aluminum, silicon, chromium, molybdenum, and carbon additions in concentrations sufficient to obtain one or more of the above benefits. The effects of these and other alloying elements are summarized as:

Carbon is added to reduce the martensite start temperature, provide solid solution strengthening, and to increase the hardenability of the steel. Carbon is an austenite stabilizer. In certain embodiments, carbon can be present in concentrations of 0.1-0.5 mass %; in other embodiments, carbon can be present in concentrations of 0.1-0.35 mass %.

Manganese is added to reduce the martensite start temperature, provide solid solution strengthening, and to increase the hardenability of the steel. Manganese is an austenite stabilizer. In certain embodiments, manganese can be present in concentrations of 1.0-10.0 mass %; in other embodiments, manganese can be present in concentrations of 1.0-6.0 mass %.

Silicon is added to provide solid solution strengthening. Silicon is a ferrite stabilizer. In certain embodiments, silicon can be present in concentrations of 0.02-2.0 mass %; in other embodiments, silicon can be present in concentrations of 0.02-1.0 mass %.

Aluminum is added for deoxidation during steelmaking and to provide solid solution strengthening. Aluminum is a ferrite stabilizer. In certain embodiments, aluminum can be present in concentrations of 0.0-2.0 mass %; in other embodiments, aluminum can be present in concentrations of 0.02-1.0 mass %.

Titanium is added to getter nitrogen. In certain embodiments, titanium can be present in concentrations of 0.0-0.045 mass %; in other embodiments, titanium can be present in concentrations of a maximum of 0.035 mass %.

Molybdenum is added to provide solid solution strengthening and to increase the hardenability of the steel. In certain embodiments, molybdenum can be present in concentrations of 0-4.0 mass %; in other embodiments, molybdenum can be present in concentrations of 0-1.0 mass %.

Chromium is added to reduce the martensite start temperature, provide solid solution strengthening, and increase the hardenability of the steel. Chromium is a ferrite stabilizer. In certain embodiments, chromium can be present in concentrations of 0-6.0 mass %; in other embodiments, chromium can be present in concentrations of 0-2.0 mass %.

Boron is added to increase the hardenability of the steel. In certain embodiments, boron can be present in concentrations of 0-0.005 mass %.

Nickel is added to provide solid solution strengthening and reduce the martensite start temperature. Nickel is an austenite stabilizer. In certain embodiments, nickel can be present in concentrations of 0.0-1.0 mass %; in other embodiments, manganese can be present in concentrations of 0.02-0.5 mass %.

TABLE 1
Composition range of a prior art press hardened steel. All
compositions are in mass %.

| Alloy | | | | | | |
|---|---|---|---|---|---|---|
| Designation | C | Mn | Si | Al | Ti | B |
| Prior Art | 0.20 | 1.21 | 0.25 | 0 | 0.032 | 0.003 |
| 22MnB5 | | | | | | |
| P | S | N | Nb | V | Cu | Sn |
| 0 | 0 | 0 | 0 | 0 | 0 | 0 |

| Ca | Mo | Ni | Cr | Fe |
|---|---|---|---|---|
| 0 | 0 | 0 | 0.19 | Bal. |

The alloys of the present application can generally be melt, cast, hot rolled, and cold rolled using processes typical for other prior art press hardened steels except that annealing after hot rolling and prior to cold rolling is required. Annealing can be performed at temperatures typically between A₁−100° C. to A₃+150° C. Annealing time will generally be longer than 10 seconds (continuous annealing) or 30 minutes (batch annealing). Another similar intermediate anneal may be required if more than one cold rolling step is required. This second intermediate anneal would occur between the first cold rolling and the second cold rolling. Furthermore, embodiments of this invention can follow one of two process paths during hot stamping:
i. Intercritical annealing of the steel sheet material prior to forming and quenching in the hot stamping dies (Process Path
ii. Full austenization of the steel sheet material prior to forming and quenching in the hot stamping dies (Process Path 2).

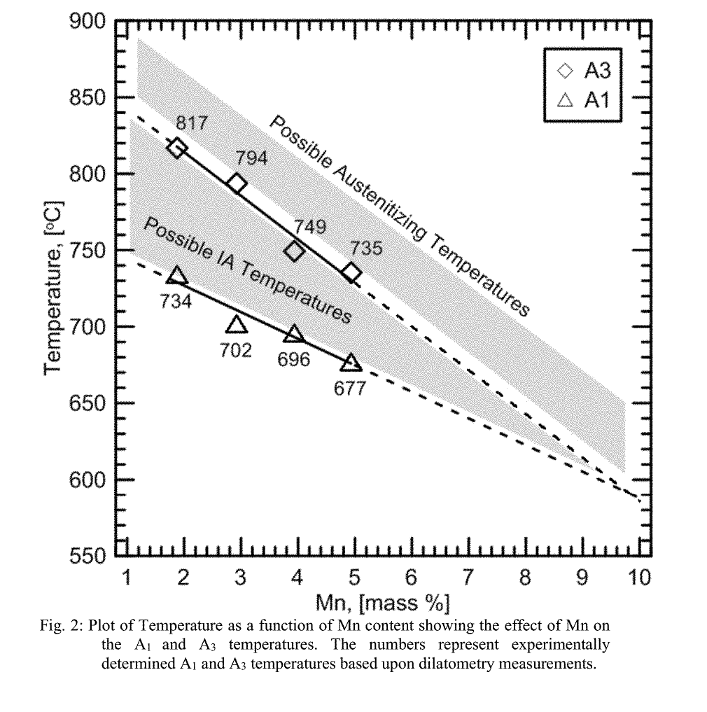

FIG. 2 presents the range of temperatures that can be used during the hot stamping process for certain embodiments of the present alloys, which is approximately 600-900° C. This temperature range includes intercritical annealing temperatures and austenitizing temperatures for certain embodiments of the present alloys that are based on a nominal Fe-0.2C—Mn-0.25Si—0.2Cr alloy containing approximately 2-5 mass percent manganese.

Process Path 1—Intercritical Annealing

During the hot stamping process, the steel sheet material can be heated to an intercritical temperature (that is, between the A₁ and A₃ temperatures) that is appropriate for the alloy composition and for a time that will provide the desired properties, as further explained below. The intercritical annealing temperature will depend on the composition of the alloy, in particular the elements manganese, aluminum, silicon, chromium, molybdenum, and carbon. The intercritical temperature range can include, but not be limited to, 600-850° C.

The time at the intercritical annealing temperature should start as soon as the steel sheet material reaches the desired intercritical annealing temperature. For example, if the IAT is 760° C., and it is required that the material be at that temperature for four and a half minutes; whether that is to achieve a desired retained austenite fraction or tensile strength, the timing should begin once the material reaches 760° C. and the material should be transferred to the die, stamped, and quenched in the dies four and a half minutes later.

The steel sheet material should be formed and then quenched in the hot stamping dies using a cooling rate that is greater than or equal to 30° C./s.

Process Path 2—Full Austenization

The material can be heated to an austenitizing temperature (that is, greater than the A₃ temperature) that is appropriate for the alloy composition. The austenitizing temperature will be determined by the composition of the alloy, in particular the elements manganese, aluminum, silicon, chromium, molybdenum, and carbon. Depending on the composition of the alloy, the A₃ temperature may be as low as approximately 600° C.

The time at the austenitizing temperature should start as soon as the material reaches the desired AT. For example, if the AT is 760° C., and it is required that the material be at that temperature for four and a half minutes, then the timing should begin once the material reaches 760° C. and the material should be transferred to the die, stamped, and quenched in the dies four and a half minutes later.

The material should be formed and then quenched in the hot stamping dies using a cooling rate greater than or equal to 30° C./s.

FIG. 2 shows the effect of manganese on the critical temperatures (A₁ and A₃ temperatures) of embodiments of the present alloys that are based on a nominal Fe-0.2C—Mn-0.25Si—0.2Cr alloy containing approximately 2-5 mass percent manganese. Critical temperatures decrease as the manganese concentration increases. This variation in critical temperatures provides great processing flexibility.

As will be apparent to one of ordinary skill in the art, the processing route and hot stamping annealing conditions will change depending on the manganese content of the alloy and the desired properties in the hot stamped condition. The time at the TAT or AT can be varied and the peak metal temperature can be varied depending on manganese content and desired mechanical properties in the hot stamped part. Ultimate tensile strength tends to increase as the TAT increases or the intercritical annealing time increases. Elongation tends to decrease as the IAT increases or as the intercritical annealing time increases. For annealing at temperatures greater than the A₃ temperature, strength decreases as the AT or time annealing time increase. Elongation is relatively unaffected by annealing time during austenitization.

Traditionally, the hot stamped microstructure for press hardened steels is fully martensitic. In those prior art steels, the fully martensitic microstructure is responsible for the high ultimate tensile strength and low residual ductility, which are characteristics of traditional press hardened steels. However, the present alloys show a range of microstructures with retained austenite fractions up to 17% by volume.

The alloys of the present application can also be coated with an aluminum-based coating or a zinc-based coating (either galvanized or galvannealled), after cold rolling and before hot stamping. Such coating can be applied to the steel sheet using processes known in the art, including hot dip coating or electrolytic coating. Because of the lower critical temperatures, press hardening of the present alloys after they have been coated is less likely to result in melting of the coating and the detrimental effects associated with such melting.

### Example 1

An alloy of the composition of Table 2 was prepared using standard steel making processes, except as noted below.

TABLE 2
Composition range. Compositions are in mass pct.

| Alloy | | | | | | |
|---|---|---|---|---|---|---|
| Designation | C | Mn | Si | Al | Ti | B |
| Alloy 1 | 0.20 | 5.09 | 0.25 | 0 | 0.034 | 0.0045 |
| P | S | N | Nb | V | Cu | Sn |
| 0 | 0.0012 | 0.0022 | 0.003 | 0 | 0 | 0.003 |

| | | | | Fe + |
|---|---|---|---|---|
| Ca | Mo | Ni | Cr | impurities |
| 0 | 0 | 0 | 0.19 | Bal. |

The numbers in FIG. 2 show the experimentally determined A₁ and A₃ temperatures for alloys containing about two, three, four, and five mass pct. manganese with the same nominal concentration of other elements. These temperatures were measured using dilatometry. The solid black lines were fit to the experimental data using linear regression. The equations for these two lines are given as follows:

A₁(% Mn)=−17.39(% Mn)+761.63 (1)

A₃(% Mn)=−28.55(% Mn)+871.25 (2)

The dashed lines of FIG. 2 are extrapolations of these two equations from two mass pct. manganese down to one mass pct. manganese and from five mass pct. up to 10 mass pct. manganese.

### Example 2

The ability to retain austenite in the as-die quenched press hardened part is a novel contribution of the present alloys.

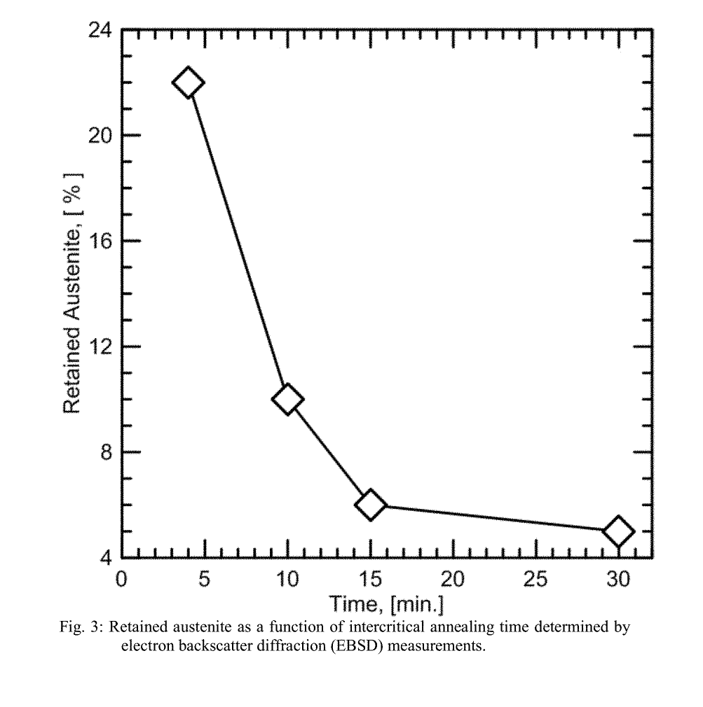

FIG. 3 shows a plot of retained austenite as a function of intercritical annealing time for embodiments of the present alloy containing 5 mass pct. manganese (Alloy 1 in Table 2). The IAT is 720° C., in this instance. However, IAT (or AT) can be varied depending on the alloy composition, desired mechanical properties, and final austenite phase fraction in the microstructure.

### Example 3

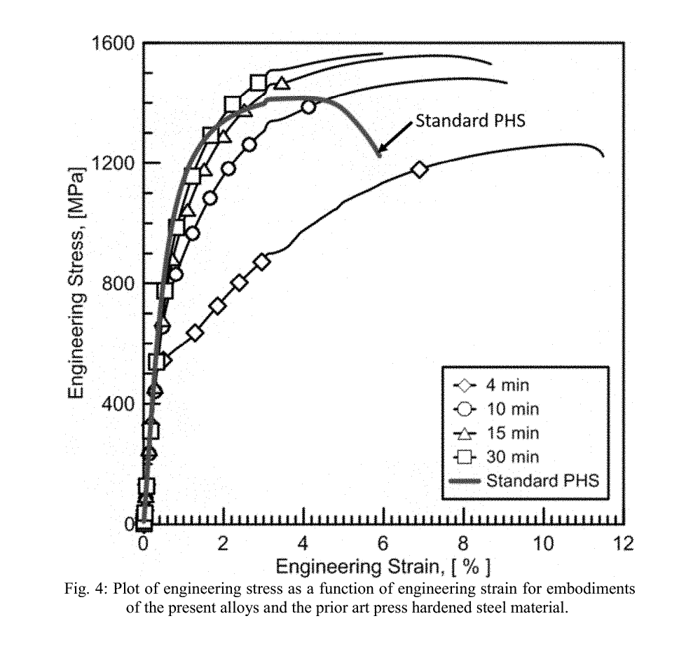

FIG. 4 presents five engineering stress-strain curves. Four of the curves are for a 5-mass pct. manganese alloy embodiment of the present application (Alloy 1 in Table 2) intercritically annealed at 720° C. for 4, 10, 15, and 30 minutes. The thick line is an engineering stress-strain curve for the prior art 22MnB5 press hardened steel of Table 1 (labeled Standard PHS). The superior mechanical properties of the present steel alloys are demonstrated. The improvement in mechanical properties is a direct result of the higher manganese concentration, flexible processing (see FIG. 2), and retained austenite in the final as-die quenched microstructure, (see FIG. 3).

### Example 4

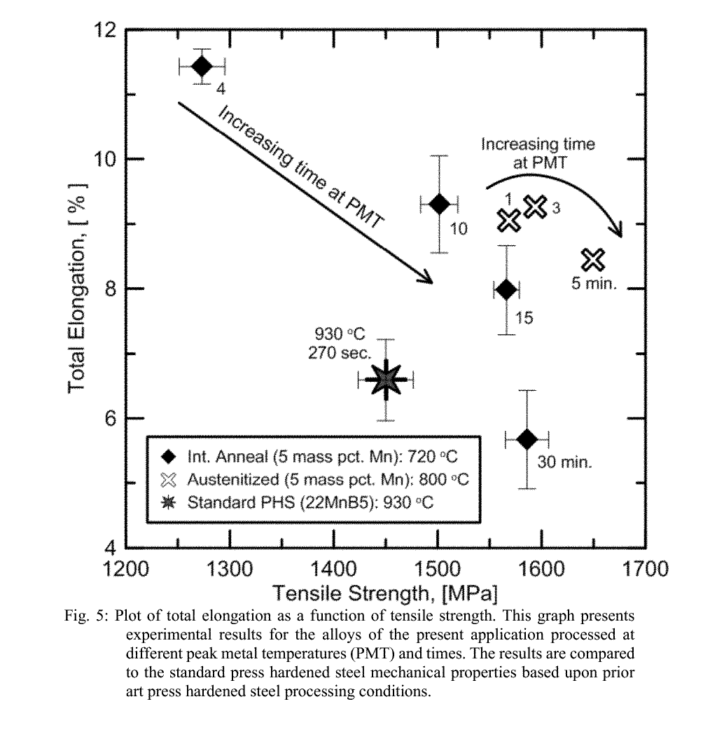

FIG. 5 is a plot of total elongation as a function of tensile strength for intercritically annealed embodiments of the present application, austenitized embodiments of the present application (Alloy 1 in Table 2), and the prior art press hardened steel alloy of Table 1 processed using traditional methods. FIG. 5 elucidates the improved mechanical properties of the alloys of the present application achieved through flexible processing afforded by increased manganese content.

The effect of time on mechanical properties can also be clearly seen in FIG. 5. The diamond shaped data points represent steel samples of Alloy 1 that were intercritically annealed for 4, 10, 15, and 30 minutes at 720° C. Samples of austenitized Alloy 1, white X's in FIG. 5, were processed for one, three, and five minutes. Properties of prior art press hardened steel of the composition of Table 2 are shown by the star-shaped data point.

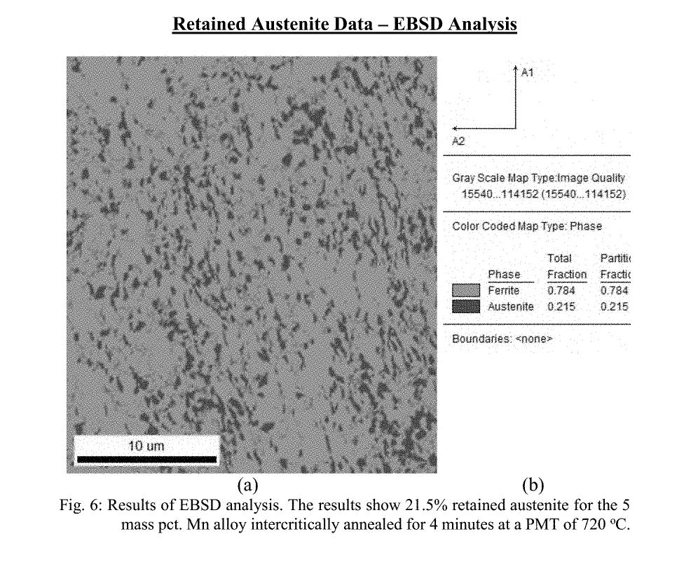

FIG. 6-9 show the results of microstructural analyses of Alloy 1 after simulated hot stamping.

FIG. 6 shows 21.5% retained austenite for a 5-mass pct. manganese alloy intercritically annealed for 4 minutes at a peak metal temperature (PMT) of 720° C. The dark portions represent the austenite phase fraction and the light portions represent the ferrite/martensite phase fraction.

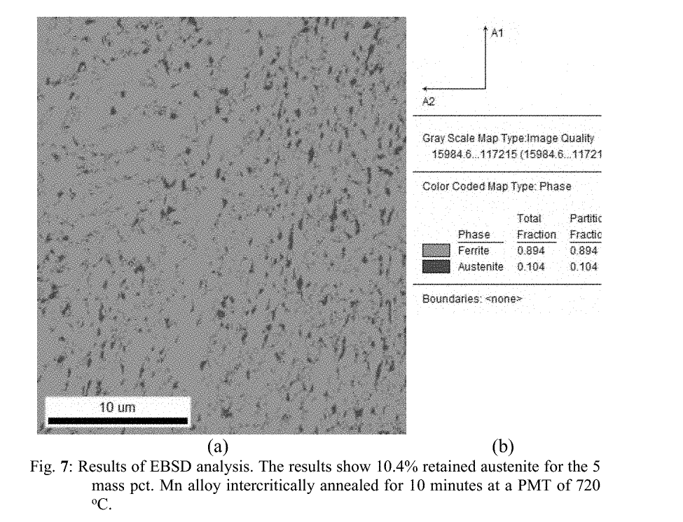

FIG. 7 shows 10.4% retained austenite for a 5-mass pct. manganese alloy intercritically annealed for 10 minutes at a PMT of 720° C. The dark portions represent the austenite phase fraction and the light portions represent the ferrite/martensite phase fraction.

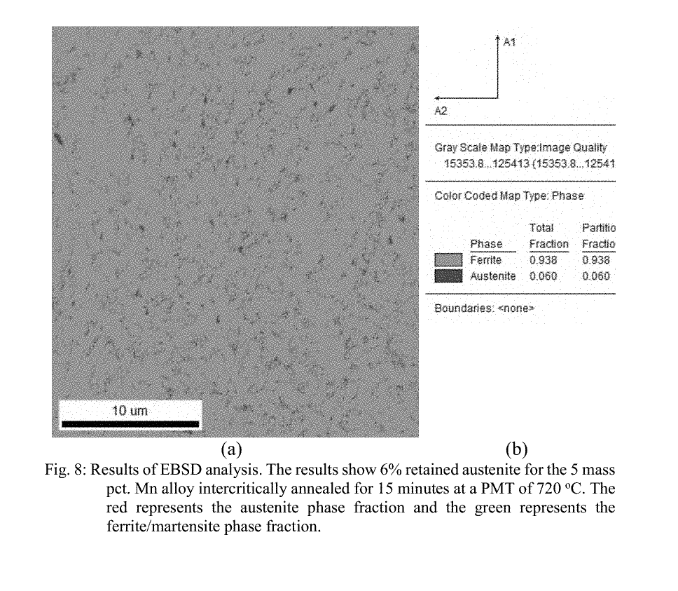

FIG. 8 shows 6% retained austenite for a 5-mass pct. manganese alloy intercritically annealed for 15 minutes at a PMT of 720° C. The dark portions represent the austenite phase fraction and the light portions represent the ferrite/martensite phase fraction.

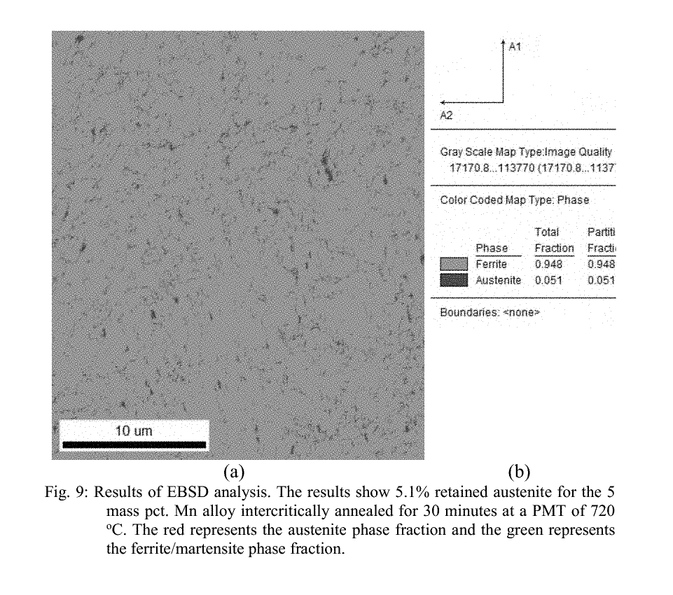

FIG. 9 shows 5.1% retained austenite for a 5-mass pct. manganese alloy intercritically annealed for 30 minutes at a PMT of 720° C. The dark portions represent the austenite phase fraction and the light portions represent the ferrite/martensite phase fraction.

### Example 5

Ingots with the compositions shown in Table 4 were studied. The alloys were vacuum melted and hot rolled to 4 mm and air cooled. The hot rolled material was then cold rolled 50% to a final thickness of 1.5 mm. Finally, the cold rolled sheets were sheared into 25.4×229 mm blanks and machined to ASTM E8 tensile samples.

TABLE 4
Chemical composition of certain embodiments
of the present alloys

| Alloy | C | B | Cr | Mn | Si | Fe |
|---|---|---|---|---|---|---|
| 4334 | 0.18 | 0.0029 | 0.20 | 2.0 | 0.24 | balance |
| 4335 | 0.20 | 0.0031 | 0.20 | 3.0 | 0.23 | balance |
| 4336 | 0.22 | 0.0034 | 0.20 | 4.0 | 0.23 | balance |
| 4337 | 0.21 | 0.0037 | 0.20 | 5.0 | 0.23 | balance |

The mechanical properties were measured by tensile tests conducted at room temperature on ASTM E8 tensile samples using an electromechanical test frame. X-ray diffraction (XRD) patterns of the heat treated and hot stamped tensile samples were obtained using a Cr source at a 20 range of 60-165° with a scanning step size of 0.1° and a dwell time of 0.1 second. Rietveld analysis of the XRD patterns was used to determine the retained austenite in the heat treated and hot stamped samples. The microstructures of the metallographic specimens were prepared using standard metallographic techniques and etched with 2 vol. % Nital and examined in a scanning electron microscope and using light optical microscopy.

Two different heat treatments were used on the samples prior to hot stamping, see Table 5. The samples were either intercritically annealed (TAT) or fully austenitized (AT) for times of 180-1200 s and then hot stamped to achieve final properties.

TABLE 5
Alloy Mn contents and peak metal temperature for heat treatments

| Alloy | Temperature (° C.) |
|---|---|
| 4334 (2% Mn) | IAT: 776 |
| | AT: 830 |
| 4335 (3% Mn) | IAT: 750 |
| | AT: 815 |
| 4336 (4% Mn) | IAT: 722 |
| | AT: 765 |
| 4337 (5% Mn) | IAT: 710 |
| | AT: 745 |

The critical temperatures were determined through dilatometry experiments using a Linseis quenching dilatometer. The dilatometer samples were sectioned from hot rolled material and machined to the following dimensions 3×3×10 mm. The dilatometer samples were heated to the desired peak metal temperature at a rate of 1° C./s, held at PMT for thirty seconds, and quenched in helium at a rate greater than 30° C./s.

Mechanical testing of the alloys of this example, annealed at various temperatures, was performed. The results are set forth in Table 3 below.

TABLE 3

| | | | 0.2% Offset | Ultimate | Total |
|---|---|---|---|---|---|
| | Annealing | Annealing | Yield | Tensile | Elongation |
| | Temperature | Time | Strength | Strength | in 50 mm |
| Alloy | (° C.) | (s) | (MPa) | (MPa) | (%) |
| 4334 | 776 | 300 | 426 | 901 | 10.3 |
| 4334 | 776 | 600 | 525 | 1013 | 9.6 |
| 4334 | 776 | 900 | 499 | 984 | 10.5 |
| 4334 | 776 | 1200 | 529 | 1018 | 9.8 |
| 4334 | 830 | 300 | 624 | 986 | 8.1 |
| 4334 | 830 | 600 | 713 | 1068 | 6.6 |
| 4334 | 830 | 900 | 789 | 1165 | 6.7 |
| 4334 | 830 | 1200 | 746 | 1089 | 6.4 |
| 4335 | 750 | 300 | 805 | 1356 | 8.1 |
| 4335 | 750 | 600 | 916 | 1411 | 8.5 |
| 4335 | 750 | 900 | 894 | 1381 | 8.9 |
| 4335 | 750 | 1200 | 939 | 1443 | 9.1 |
| 4335 | 815 | 300 | 1022 | 1429 | 7.4 |
| 4335 | 815 | 600 | 1027 | 1416 | 8.1 |
| 4335 | 815 | 900 | 1006 | 1386 | 6.4 |
| 4335 | 815 | 1200 | 1022 | 1407 | 7.6 |
| 4336 | 710 | 300 | 594 | 1037 | 11.7 |
| 4336 | 710 | 600 | 670 | 1238 | 9.4 |
| 4336 | 710 | 900 | 693 | 1308 | 9.4 |
| 4336 | 730 | 300 | 730 | 1320 | 7.1 |
| 4336 | 730 | 600 | 858 | 1497 | 7.8 |
| 4336 | 730 | 900 | 880 | 1490 | 7.8 |
| 4336 | 740 | 300 | 904 | 1581 | 6.1 |
| 4336 | 740 | 600 | 981 | 1609 | 8.3 |
| 4336 | 740 | 900 | 909 | 962 | 15.4 |
| 4337 | 700 | 300 | 844 | 979 | 17 |
| 4337 | 700 | 600 | 674 | 1099 | 16.4 |
| 4337 | 700 | 900 | 414 | 1307 | 10.1 |
| 4337 | 715 | 300 | 644 | 1447 | 8.4 |
| 4337 | 715 | 600 | 901 | 1681 | 7.2 |
| 4337 | 715 | 900 | 887 | 1665 | 6.4 |
| 4337 | 725 | 300 | 934 | 1686 | 6.8 |
| 4337 | 725 | 600 | 1149 | 1855 | 5.1 |
| 4337 | 725 | 900 | 1113 | 1819 | 4.6 |

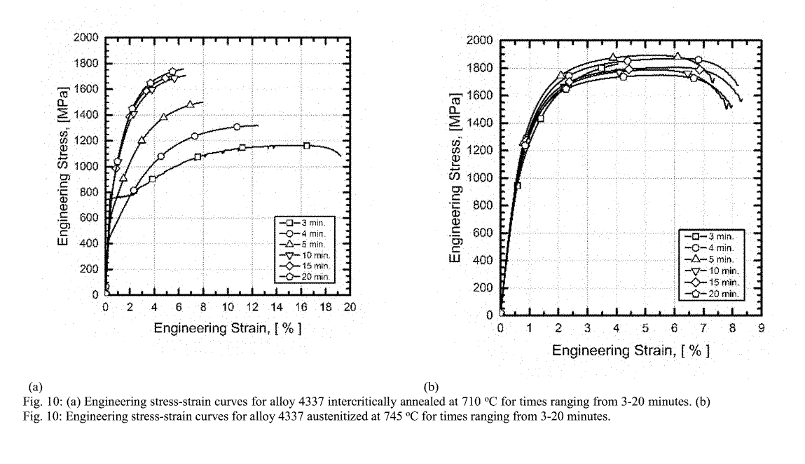

FIG. 10A shows the engineering stress strain curves for alloy 4337 processed at an IAT of 710° C. for times ranging from 3 to 20 minutes. FIG. 10B provides results of alloy 4337 for samples that were fully austenitized at a peak metal temperature of 745° C. for times ranging from 3 to 20 minutes. As can be seen from the figure, the maximum elongation obtained was approximately 8% with a tensile strength greater than 1800 MPa.

As can be seen from the FIG. 10A, the intercritical annealing heat treatment provided a large range of properties in the final hot stamped part. The intercritical annealing times range from three to 20 minutes for an IAT of 710° C. The three minute intercritically annealed sample exhibited a high total elongation and yield point elongation. The low intercritical temperature also results in a significant amount of retained austenite (17%) in the as-hot stamped microstructure for certain processing conditions.

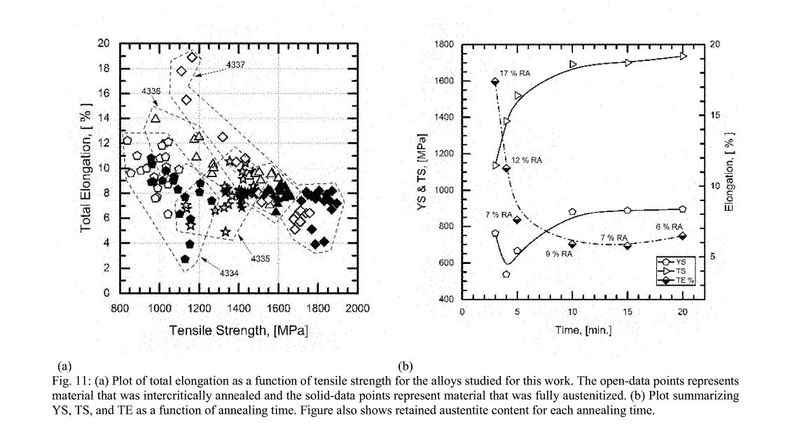

FIG. 11A shows a plot summarizing the mechanical properties for the alloys of this Example 5 tested under various conditions. The open-data points represent samples that were intercritically annealed prior to hot stamping. The solid-data points represent samples that were fully austenitized prior to hot stamping. FIG. 11B shows yield and ultimate tensile strength and total elongation as a function of time at the peak metal temperature for Alloy 4337. Additionally, retained austenite fraction as a function of time at the annealing temperature is provided. Short intercritical annealing and austenitizing times and low peak metal temperatures of a 0.2C-(2-5)Mn PHS alloy produced a broad range of mechanical properties. The intercritical annealing peak metal temperatures ranged from 710-776° C. and the times at PMT range from 3-20 minutes. The austenitizing peak metal temperature ranged from 745-830° C. and times at PMT ranged from 3-20 minutes.

The flexibility in processing was afforded by the increased manganese levels not typically associated with press hardened steels. It was also shown that substantial austenite fractions could be retained in the heat treated and hot stamped part. The range of tensile properties is likely the result of having retained austenite of varying stability in the heat treated and hot stamped microstructure. The conditions of short intercritical annealing and austenitizing times, low peak metal temperatures, and elevated manganese levels produced mechanical property results that are desirable for structural components in automobile structures.

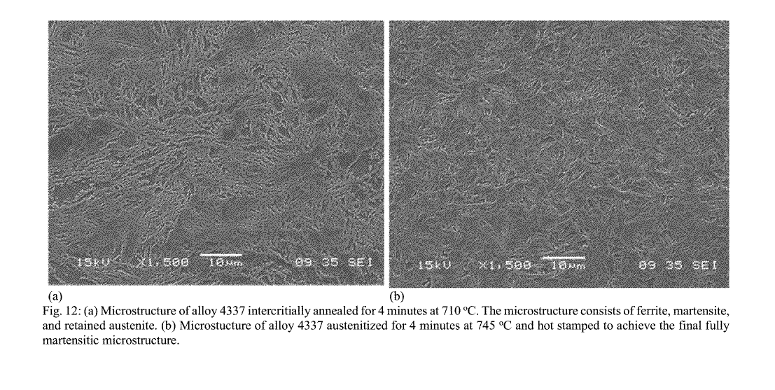

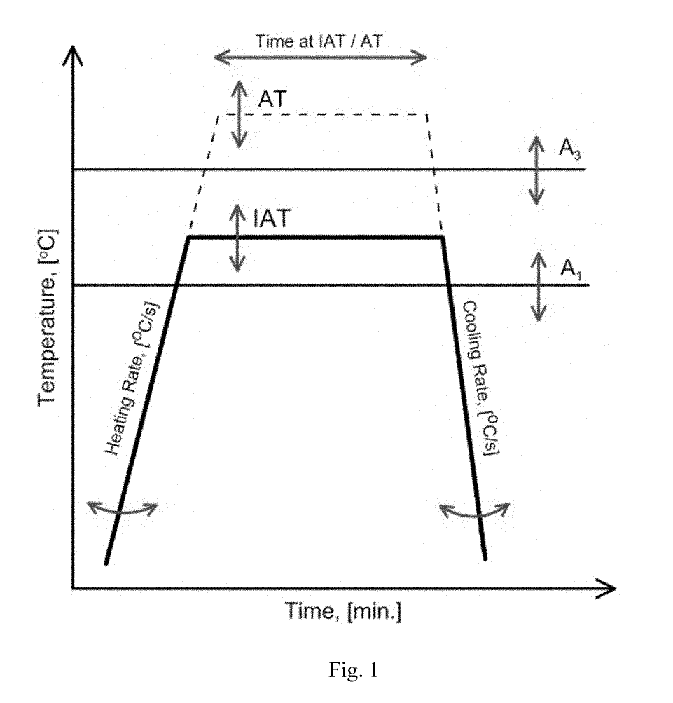

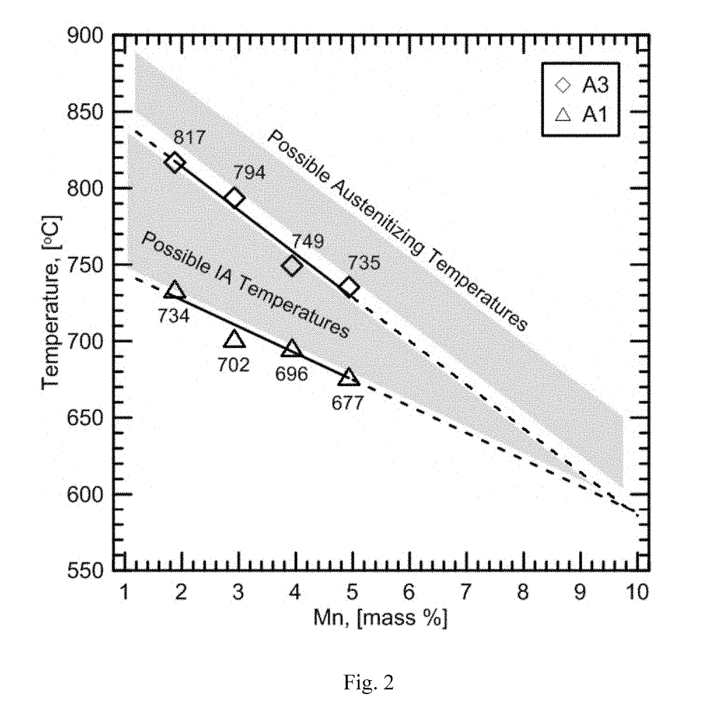

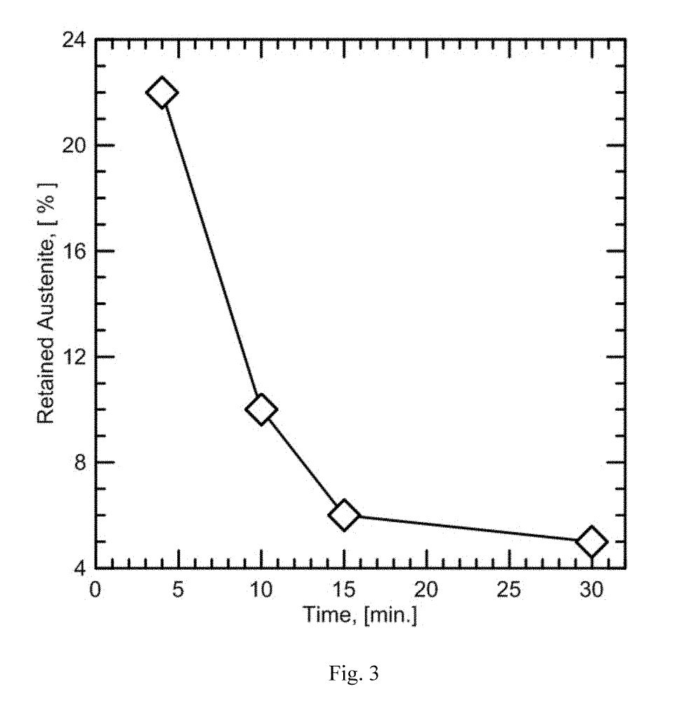

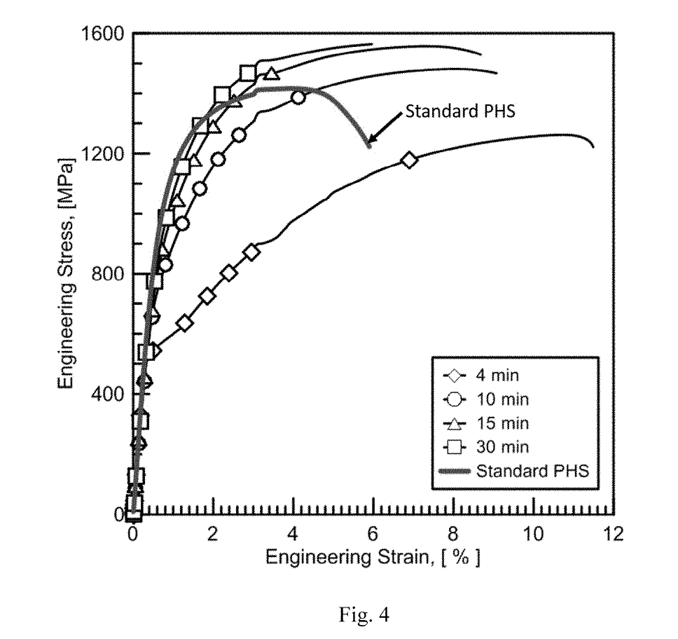

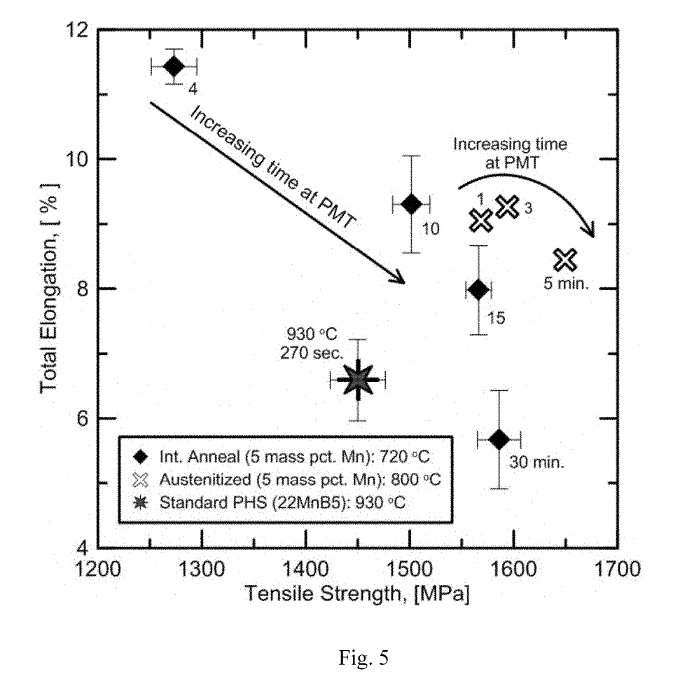

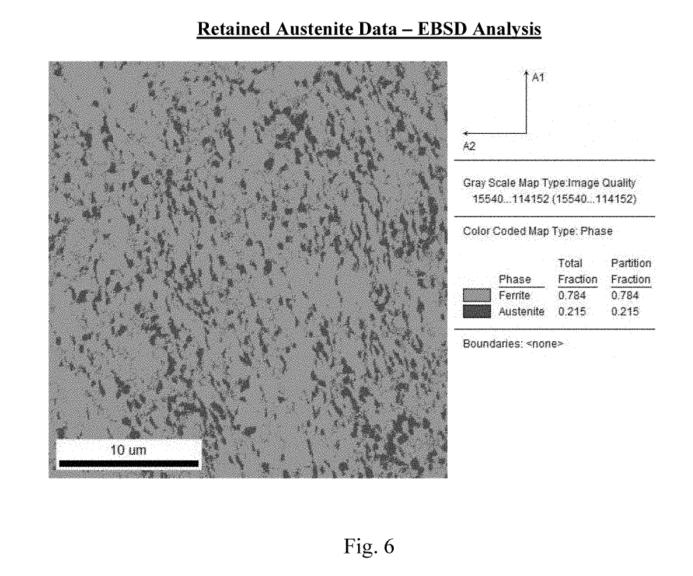

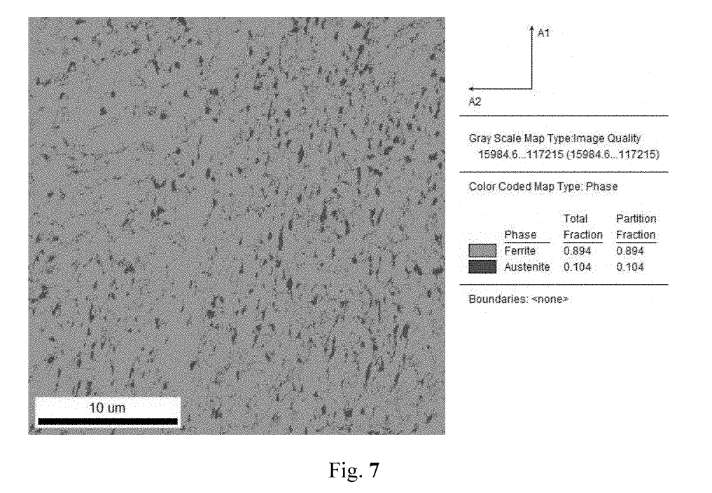

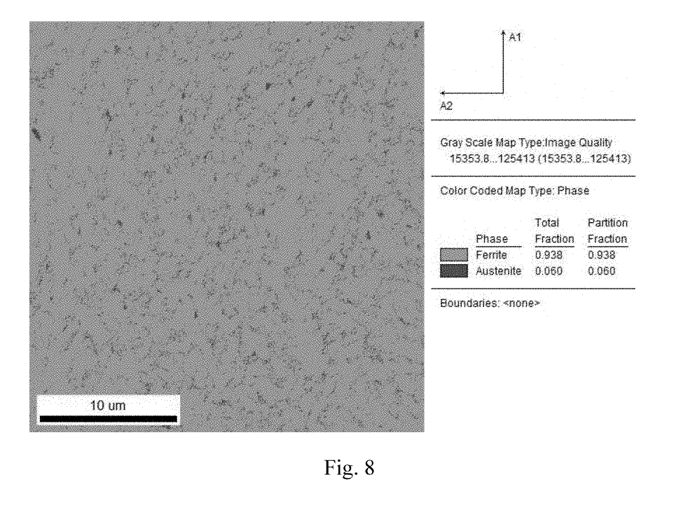

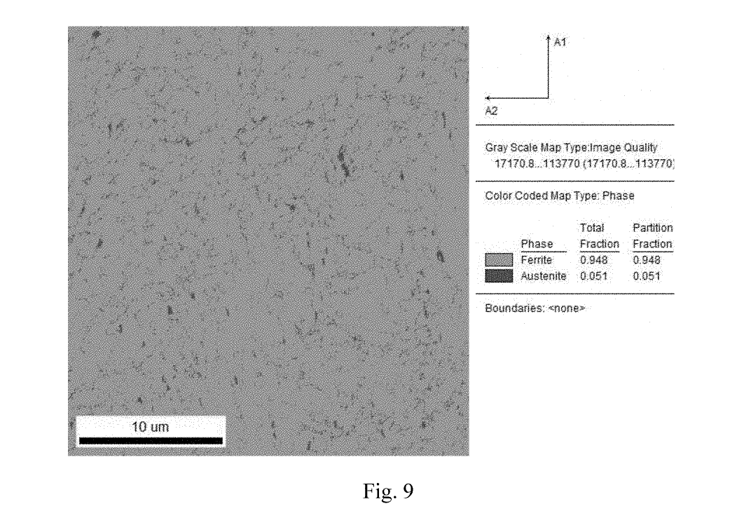

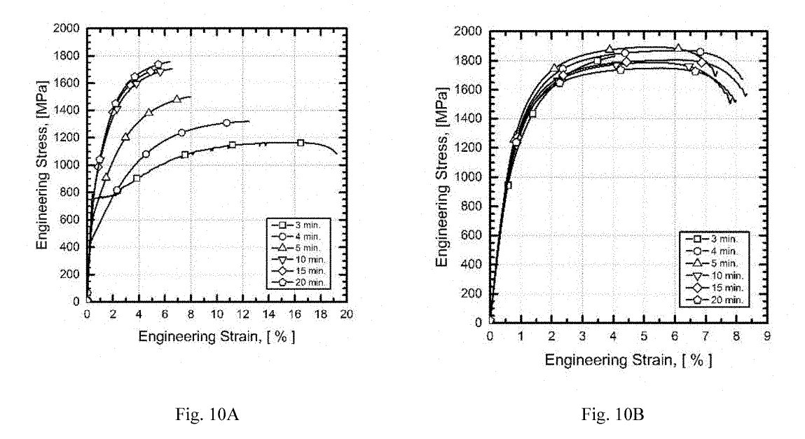

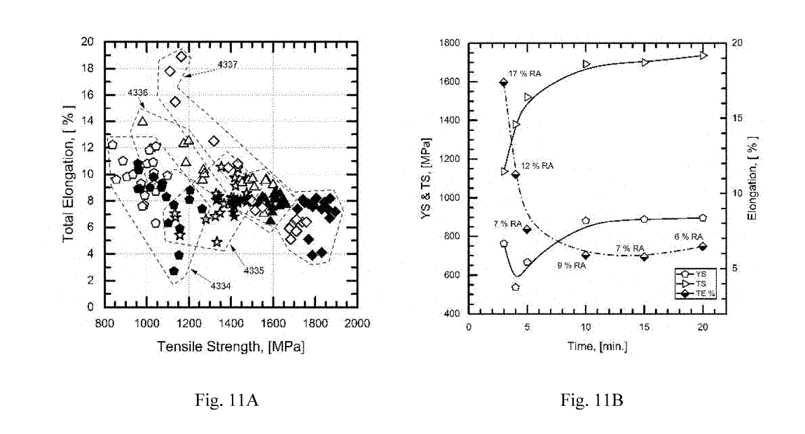

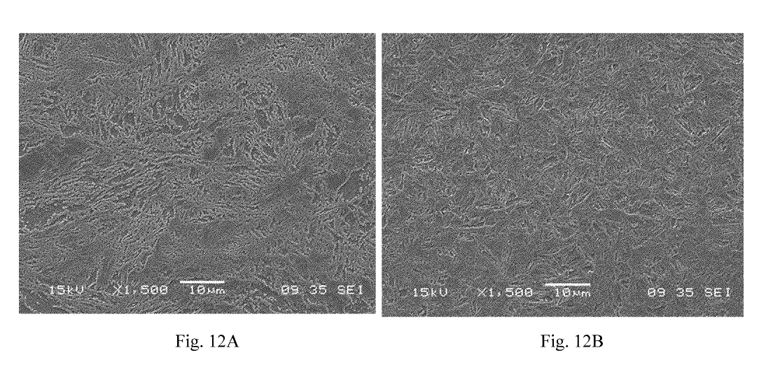

FIG. 12A shows the microstructure of alloy 4337 intercritically annealed for four minutes at 710° C. This microstructure consists of ferrite, martensite, and retained austenite. FIG. 12B shows a microstructure that fully martensitic. This material was austenitized at 745° C. for four minutes and hot stamped to achieve the final microstructure and properties.

Increased manganese coupled with intercritical annealing or a full austenitizing heat treatment results in a material with improved residual ductility or a higher strength-lower ductility press hardenable material, respectively.

### Example 6

A press hardenable steel comprising by total mass percentage of the steel:

(a) from 0.1% to 0.5%, preferably from 0.1% to 0.35%, Carbon;

(b) from 1.0% to 10.0%, preferably from 1.0% to 6.0%, Manganese; and

(c) from 0.02% to 2.0%, preferably from 0.02% to 1.0%, Silicon;

wherein said steel is intercritically annealed or substantially fully austenitized prior to forming and quenching in a hot stamping die.

### Example 7

A press hardenable steel of Example 6 or any one of the following

Examples, further comprising from 0.0% to 2.0% Aluminum.

### Example 8

A press hardenable steel of either one of Examples 6 and 7, or any one of the following Examples, further comprising from 0.02% to 1.0% Aluminum.

### Example 9

A press hardenable steel of any one of Examples 6 through 8, or any one of the following Examples, further comprising from 0.0% to 0.045% Titanium.

### Example 10

A press hardenable steel of any one Examples 6 through 9, or any one of the following Examples, further comprising no more than 0.035% Titanium.

### Example 11

A press hardenable steel of any Examples 6 through 10, or any one of the following Examples, further comprising from 0% to 4.0% Molybdenum.

### Example 12

A press hardenable steel of any one of Examples 6 through 11, or any one of the following Examples, further comprising from 0% to 1.0% Molybdenum.

### Example 13

A press hardenable steel of any one of Examples 6 through 12, or any one of the following Examples, further comprising from 0% to 6.0% Chromium.

### Example 14

A press hardenable steel of any one of Examples 6 through 13, or any one of the following Examples, further comprising from 0% to 2.0% Chromium.

### Example 15

A press hardenable steel of any one of Examples 6 through 14, or any one of the following Examples, further comprising from 0.0% to 1.0% Ni.

### Example 16

A press hardenable steel of any one of Examples 6 through 15, or any one of the following Examples, further comprising from 0.02% to 0.5% Ni.

### Example 17

A press hardenable steel of any one of Examples 6 through 16, or any one of the following Examples, further comprising from 0% to 0.005% Boron.

### Example 18

A press hardenable steel of any one of Examples 6 through 17, or any one of the following Examples, wherein the hardenable steel has, after press hardening or hot stamping, an ultimate tensile strength of at least 1100 MPa and a residual ductility of at least 8%.

### Example 19

A press hardenable steel of any one of Examples 6 through 18, wherein the hardenable steel has, after press hardening or hot stamping, an ultimate tensile strength of at least 1200 MPa and a residual ductility of at least 12%.

### Example 20

A press hardenable steel of any one of any one of Examples 6 through 19, wherein the hardenable steel has an aluminum-based coating or a zinc-based coating.

What is claimed is:

1. A press hardenable steel comprising 0.1-0.5 mass % C, 1.0-10.0 mass % Mn, 0.02-2.0 mass % Si, 0.0-2.0 mass % Al, 0.0-0.045 mass % Ti, 0-4.0 mass % Mo, 0-6.0 mass % Cr, 0.0-1.0 mass % Ni, 0-0.005 mass % B, wherein said steel is intercritically annealed or substantially fully austenitized prior to forming and quenching in a hot stamping die.

2. The press hardenable steel of claim 1 comprising 0.1-0.35 mass % C.

3. The press hardenable steel of claim 1 comprising 1.0-6.0 mass % Mn.

4. The press hardenable steel of claim 1 comprising 0.02-1.0 mass % Si.

5. The press hardenable steel of claim 1 comprising 0.02-1.0 mass % Al.

6. The press hardenable steel of claim 1 comprising no more than 0.035 mass % Ti.

7. The press hardenable steel of claim 1 comprising 0-1.0 mass % Mo.

8. The press hardenable steel of claim 1 comprising 0-2.0 mass % Cr.

9. The press hardenable steel of claim 1 comprising 0.02-0.5 mass % Ni.

10. The press hardenable steel of claim 1, wherein the press hardenable steel has, after press hardening or hot stamping, an ultimate tensile strength of at least 1100 megapascals and a residual ductility of at least 8%.

11. The press hardenable steel of claim 1, wherein the press hardenable steel has, after press hardening or hot stamping, an ultimate tensile strength of at least 1200 megapascals and a residual ductility of at least 12%.

12. The press hardenable steel of claim 1, wherein the press hardenable steel includes an aluminum-based coating or a zinc-based coating.
